(19) United States
(12) Patent Application Publication
(10) Pub. No.: US 2012/0026208 A1
(43) Pub. Date: Feb. 2, 2012

(54) Image display apparatus

(75) Inventors: Hisashi Kobiki, Kanagawa-ken (JP); Ryosuke Nonaka, Kanagawa-ken (JP); Masahiro Baba, Kanagawa-ken (JP)

(73) Assignee: KABUSHIKI KAISHA TOSHIBA, Tokyo (JP)

(21) Appl. No.: 13/064,085

(22) Filed: Mar. 4, 2011

(30) Foreign Application Priority Data
Jul. 30, 2010 (JP) 2010-172735

(51) Int. Cl. G09G 5/10

(52) U.S. Cl. 345/690

(57) ABSTRACT

According to one embodiment, a set unit sets a display luminance signal indicating a luminance of a display unit. A first calculation unit calculates a first gamma characteristic signal of an image to be displayed, based on the display luminance signal and gray-scale levels of pixels of the image. A second calculation unit calculates a second gamma characteristic signal of each area of the image, based on gray-scale levels of pixels of each area. A conversion unit converts a gray-scale level of each pixel of the image, based on the first gamma characteristic signal and the second gamma characteristic signal of an area including a pixel to be converted in the image. The display unit displays the image in which the gray-scale level of each pixel was converted, based on the display luminance signal.

### CROSS-REFERENCE TO RELATED APPLICATION

This application is based upon and claims the benefit of priority from Japanese Patent Application No. 2010-172735, filed on Jul. 30, 2010; the entire contents of which are incorporated herein by reference.

### FIELD

Embodiments described herein relate generally to an apparatus for displaying an image.

### BACKGROUND

As to an apparatus for displaying an image having gradation (gray-scale levels), in order to save a power of the apparatus, processing to reduce a peak luminance of the apparatus is executed. However, when the peak luminance is reduced, a dynamic range of a display of the apparatus also drops. Because, by reducing the peak luminance, a luminance-difference of gray-scale level between a dark part (low gray-scale level part) and a bright part (high gray-scale level part) in the image is shortened.

A technique to solve above-mentioned problem is disclosed in JP-A 2009-17200 (Kokai). As to this technique, the total of luminance histogram (representing a frequency of appearance of gray-scale level) of the dark part and the bright part in the image is calculated respectively, and γ-curve to raise the luminance and γ-curve to lower the luminance are generated from the total of luminance histogram. Then, new γ-curve to blend above-mentioned two γ-curves is generated.

However, in this technique, a gain of the new γ-curve is uniformly set in the image, based on the frequency of appearance of gray-scale level in the dark part and the bright part. Accordingly, at the dark part or the bright part having low frequency of appearance, the luminance-difference of gray-scale level is shortened, and a loss of gradation occurs.

### BRIEF DESCRIPTION OF THE DRAWINGS

FIG. 1 is a block diagram of an image display apparatus according to a first embodiment.

FIG. 2 is a block diagram of a conversion unit in FIG. 1.

FIG. 3 is a flow chart of processing of the image display apparatus in FIG. 1.

FIG. 4 is a graph showing an operation of a global-gamma calculation unit in FIG. 1.

FIG. 5 is a graph showing an operation of a local-gamma calculation unit in FIG. 1.

FIG. 6 is a graph showing an operation of a conversion unit in FIG. 1.

### DETAILED DESCRIPTION

According to one embodiment, an image display apparatus includes a display unit, a set unit, a first calculation unit, a second calculation unit, and a conversion unit. The set unit is configured to set a display luminance signal indicating a luminance of the display unit. The first calculation unit is configured to calculate a first gamma characteristic signal of an image to be displayed, based on the display luminance signal and gray-scale levels of pixels of the image. The second calculation unit is configured to calculate a second gamma characteristic signal of each area of the image, based on gray-scale levels of pixels of each area. The conversion unit is configured to convert a grayscale level of each pixel of the image, based on the first gamma characteristic signal and the second gamma characteristic signal of an area including a pixel to be converted in the image. The display unit displays the image in which the gray-scale level of each pixel was converted, based on the display luminance signal.

Various embodiments will be described hereinafter with reference to the accompanying drawings. Moreover, as to components and processes having the same operation, common sign is assigned to each component and process, and its overlapped explanation is omitted.

### The First Embodiment

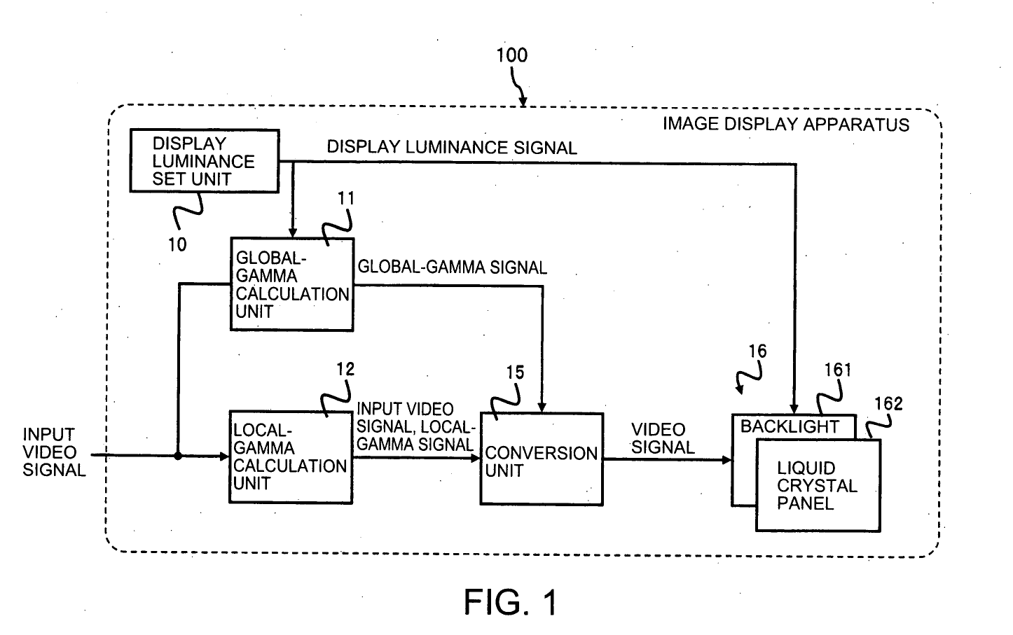

FIG. 1 is a block diagram of an image display apparatus 100 according to the first embodiment. As shown in FIG. 1, the image display apparatus 100 includes a display luminance set unit 10, a global-gamma calculation unit 11, a local-gamma calculation unit 12, a conversion unit 15, and a display unit 16 to display an image.

A format of an input video signal can be variously supposed. As to the first embodiment, an example based on YCbCr transmission standards of “International Telecommunication Union” is explained. As to the YCbCr transmission standards, each pixel has three-channel signals of a luminance element, a red-green element and a blue-yellow element as a pixel value. Among a video signal at a position (u,v) in the image, the luminance element is mentioned as a gray-scale level x(u,v). The input video signal may be an input image from all devices or all media. For example, the video signal may be input from a recording medium such as HDD, an external device connected via a network, or a broadcast wave such as TV.

The display luminance set unit 10 sets a display luminance signal indicating a peak luminance for the display unit 16 to display the image. Based on a display-parameter (related to the video signal) inputted by a user via an interface (not shown in Fig.), the display luminance set unit 10 sets the display luminance signal. Alternatively, by equipping an illumination sensor (not shown in Fig.), based on an illuminance of an environment (where the image display apparatus 10 is located) measured by the illumination sensor, the display luminance set unit 10 may set the display luminance signal. For example, the display luminance signal is set so that the peal luminance is higher when the illuminance is high and so that the peal luminance is lower when the illuminace is low.

Furthermore, if the image display apparatus 100 is driven by a buttery (not shown in Fig.), based on a remained quantity of the buttery, the display luminance set unit 10 may set the display luminance signal. For example, the display luminance signal is set so that the peal luminance is higher when the remained quantity is much and the peal luminance is lower when the remained quantity is few. This display luminance signal is sent to the global-gamma calculation unit 11 and the display unit 16.

Based on the display luminance signal, the global-gamma calculation unit 11 calculates one global-gamma signal (representing gamma characteristic) for the input video signal of a processing object, and sends it to the conversion unit 15. Briefly, one global-gamma signal is calculated for one image (one frame or one field).

As to each area in the input video signal, the local-gamma calculation unit 12 calculates a local-gamma signal (representing gamma characteristic) based on pixel values in each area, and sends it to the conversion unit 15. The local-gamma calculation unit 12 divides the input video signal into small areas of (M×N) units, and calculates a histogram of pixel values in (m,n)-th small area. Based on the histogram of pixel values in the (m,n)-th small area, the local-gamma calculation unit 12 calculates the local-gamma signal holding local characteristics of gradation of the (m,n)-th small area.

By using the global-gamma signal and the local-gamma signal (corresponding to an area to be converted), the conversion unit 15 converts a gray-scale level of each pixel of the input video signal to a video signal. Detail component of the conversion unit 15 will be explained afterwards.

The display unit 16 displays the image. In the first embodiment, an example that the display unit 16 is a liquid crystal display is explained. For that reason, the display unit 16 equips a backlight 161 and a liquid crystal panel 162. The backlight 161 is lightened at a luminance based on the display luminance signal. Furthermore, by writing the video signal having gamma characteristic (converted by the conversion unit 15) into the liquid crystal panel 162, the image is displayed.

Moreover, the display unit 16 may be any unit able to display information such as the image. For example, an organic EL panel, a plasma display panel or a CRT, may be used. In case of using a display device of self-emission type such as the organic EL panel, the display luminance signal means a peak luminance of emission of a display element, and the video signal means a signal value assigned to each display element. By controlling a gain of a driving electric current flown into each element based on the display-luminance signal, each element emits based on the video signal and the gain. As a result, the image is displayed.

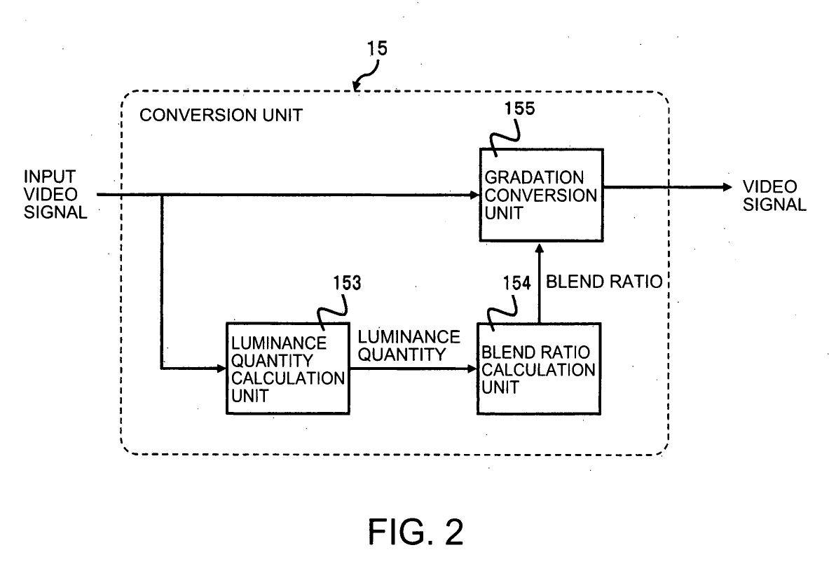

FIG. 2 is a detail component of the conversion unit 15. The conversion unit 15 includes a luminance quantity calculation unit 153, a blend ratio calculation unit 154, and a gradation conversion unit 155.

By using the input video signal, the luminance quantity calculation unit 153 calculates a luminance quantity representing a distribution of spatial luminance in the image.

By using the luminance quantity, the blend ratio calculation unit 154 calculates a blend ratio representing a composition degree between the global-gamma signal and the local-gamma signal, and sends it to the gradation conversion unit 155. The blend ratio may be calculated for each pixel, or calculated for a surrounding area including the pixel.

By using the global-gamma signal, the local-gamma signal and the blend ratio, the gradation conversion unit 155 computes a video signal, and send it to the display unit 16. The video signal has a gray-scale level converted from the input video signal.

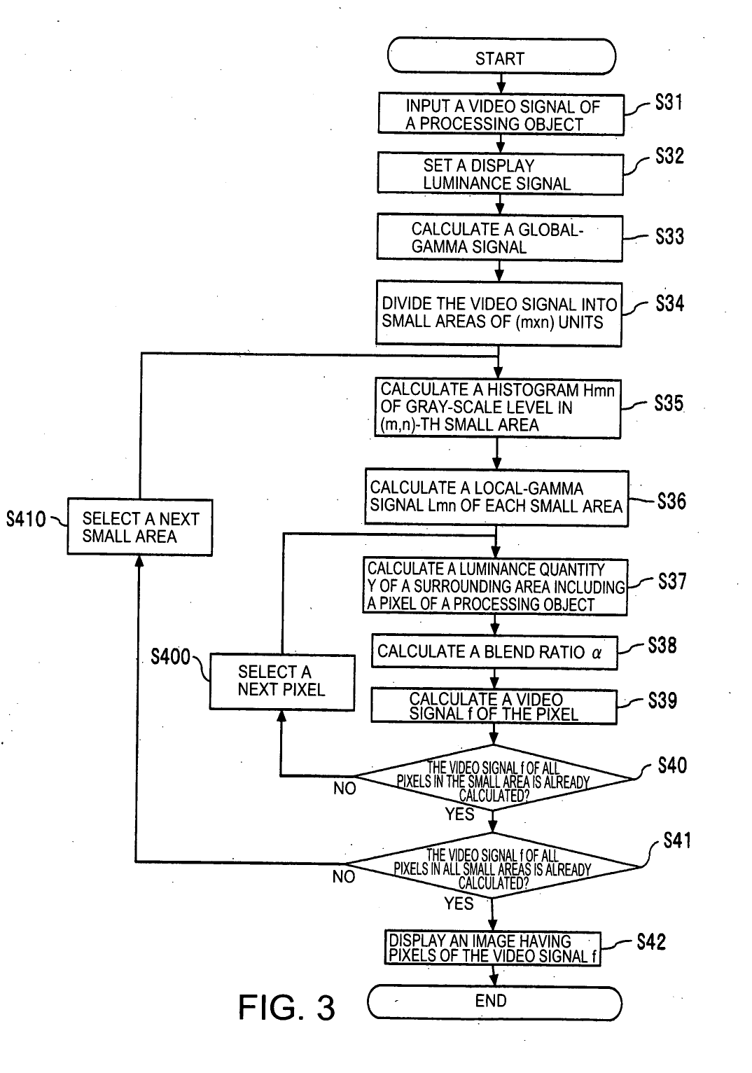

FIG. 3 is a flow chart of operation of the image display apparatus 100. First, a video signal of a processing object is input to the image display apparatus 100 (S31). The display luminance set unit 10 sets a display luminance signal “pl” indicating a display luminance of the display unit 16 in case of displaying the input video signal (S32). As mentioned-above, various methods may be used as a method for setting the display luminance signal.

By using the display luminance signal “pl”, the global-gamma calculation unit 11 calculates a global-gamma signal “G” as gamma characteristic uniformly determined for the display (S33). The global-gamma signal “G” is represented as a following equation (1).

$$G = {[ {( \frac{x}{{x}_{max}} )}^{γ} \frac{PL}{pl} ]}^{\frac{1}{γ}} \times {x}_{max} \qquad ( 1 )$$

In the equation (1), “x” represents a gray-scale level of the input video signal, “xₘₐₓ” represents a maximum of the gray-scale level of the input video signal, “γ” represents a gamma determined from characteristics of the display unit 16, and “PL” represents a maximum of the display luminance signal settable by the display luminance set unit 10.

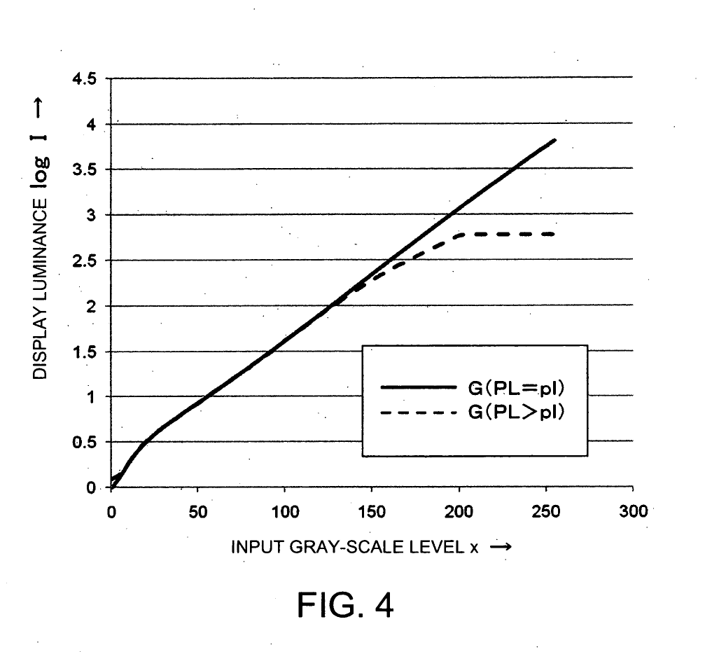

FIG. 4 shows one example of the global-gamma signal “G”. This example represents display characteristics of the display unit 16 for the gray-scale level “x” in case of “PL=pl” and “PL>pl”. In order to prevent a loss of gradation at high gray-scale level, a high gray-scale level part of the global-gamma signal “G” is desirably rounded.

The local-gamma calculation unit 12 divides the input video signal into small areas of (M×N) units (S34). A shape of small area can be variously supposed. In the first embodiment, by dividing the input video signal into M units along a horizontal direction and N units along a vertical direction, rectangle small areas of (M×N) units are supposed. Moreover, the small area may be a non-linear shape area by clustering the input video signal into “a person” or “an object”.

The local-gamma calculation unit 12 calculates a histogram Hₘₙ of gray-scale level of pixels included in (m,n)-th small area (S35). As to the histogram, bins of “xₘₐₓ” units as the maximum of gray-scale level are desirably prepared.

At S35, the histogram Hₘₙ is calculated from gray-scale levels of pixels included in (m,n)-th small area. However, this search area may be extended to a surrounding area including the (m,n)-th small area. For example, by referring to gray-scale levels of pixels included in the surrounding area such as (m−1,n−1)-th area, (m, n−1)-th area, (m+1,n−1)-th area, (m−1,n)-th area, (m,n)-th area, (m+1,n)-th area, (m−1,n+1)-th area, (m,n+1)-th area and (m+1,n+1)-th area, the histogram of gray-scale level of (m,n)-th area may be calculated. In this way, by creating the histogram Hₘₙ, difference of shape of histogram among all areas becomes small. Accordingly, occurrence of uneven luminance due to difference of the local-gamma signal (calculated at next step S36) can be suppressed.

By using the histogram Hₘₙ, the local-gamma calculation unit 12 calculates a local-gamma signal Lₘₙ holding local characteristics of gradation of (m,n)-th small area, and sends it to the conversion unit 15 (S36). The local-gamma signal Lₘₙ is calculated by following equation (2).

$$Lmn = arg min ( E ( x , pl ) ) \\ E ( x , pl ) = λ {\sum }_{x = 0}^{{x}_{max}} \vert R ( x , PL ) - r ( x , pl ) \vert {w}_{α} ( x ) + ( 1 - λ ) {\sum }_{x = 0}^{{x}_{max}} \vert \frac{d}{d x} R ( x , PL ) - \frac{d}{d x} r ( x , pl ) \vert {w}_{β} ( x ) \qquad ( 2 )$$

In the equation (2), a first term represents a square-error of brightness in case of the display luminance signal “pl and PL”. A second term represents a square-error of gradient of brightness in case of the display luminance signal “pl and PL”. “E(x,pl)” represents an evaluation value of Lₘₙ in case of the display luminance signal “pl”. “x” represents a gray-scale level of the input video signal, “R(x,PL)” represents a brightness of gray-scale level “x” in case of the display luminance signal “PL”. “r(x,pl)” represents a brightness of gray-scale level “x” in case of the display luminance signal “pl”. “λ,” represents a coefficient of linear combination of two weighted square-errors, which is desirably a value smaller than 0.5. Furthermore, “wα(x) and wβ(x)” represent a function of linear combination of the first term and the second term.

In the first embodiment, a method for calculating Lₘₙ(x) is explained. On condition that “xₘₐₓ=256”, an output gray-scale level Lₘₙ(x_{0,1}) of 128 gray-scale level as an internally dividing point between 0 gray-scale level and 256 gray-scale level is calculated. Next, an output gray-scale level Lₘₙ(x_{1,1}) of 64 gray-scale level as an internally dividing point between 0 gray-scale level and 128 gray-scale level is calculated, and an output gray-scale level Lₘₙ(x_{1,3}) of 1.92 gray-scale level as an internally dividing point between 129 gray-scale level and 256 gray-scale level. Hereinafter, above-mentioned processing is repeated until gray-scale levels of all internally dividing points are determined. In this case, a hierarchical number of the repeat processing is represented by “l”, a position number of input/output gray-scale level is represented by “p”, and an input gray-scale level of each hierarchy is represented as “x_{l,p}”.

Now, as to an internally dividing point x_{l,p} between two input gray-scale levels x_{i,p-1} and x_{i,p+1}, calculation of an output gray-scale level Lₘₙ(x_{l,p}) of the point x_{l,p} is thought about. In this case, by representing the histogram Hₘₙ as two partial histograms counting frequency of gray-scale levels “x_{i,p-1}˜x_{i,p}” and “x_{i,p}˜x_{i,p+1}”, weights wα(x) and wβ(x) of gray-scale levels “x_{i,p-1}˜x_{i,p+1}” are calculated by following equation (3).

$${ω}_{α} ( {x}_{l , p} , {x}_{l , p + 1} ) = \frac{{\sum }_{i = {x}_{l , p - 1}}^{{x}_{l , p} - 1} {H}_{mn} ( i )}{( {\sum }_{i = {x}_{l , p - 1}}^{{x}_{l , p} - 1} {H}_{mn} ( i ) ) + ( {\sum }_{i = {x}_{l , p}}^{{x}_{l , p + 1} - 1} {H}_{mn} ( i ) )} \\ {ω}_{β} ( {x}_{l , p} , {x}_{l , p + 1} ) = \frac{{\sum }_{i = {x}_{l , p}}^{{x}_{l , p + 1} - 1} {H}_{mn} ( i )}{( {\sum }_{i = {x}_{l , p - 1}}^{{x}_{l , p} - 1} {H}_{mn} ( i ) ) + ( {\sum }_{i = {x}_{l , p}}^{{x}_{l , p + 1} - 1} {H}_{mn} ( i ) )} \qquad ( 3 )$$

In the equation (3), Hₘₙ(i) represents frequency of appearance of gray-scale level “i” in (m,n)-th small area.

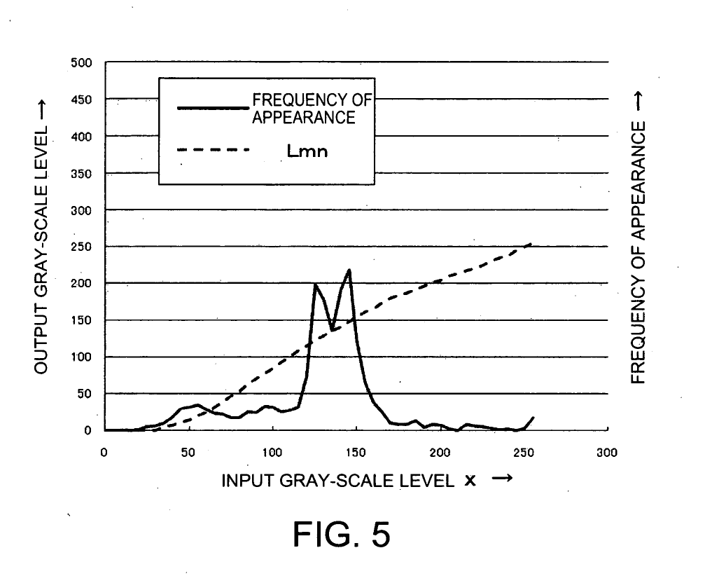

FIG. 5 is a graph showing calculation example of Lₘₙ in (m,n)-th small area in case of the display luminance signal “pl”. In this graph, a horizontal axis represents gray-scale levels, a solid line in a vertical axis represents frequency of appearance, and a broken line in the vertical axis represents output characteristic of a local-gamma signal Lₘₙ. As shown in the local-gamma signal Lₘₙ of FIG. 5, as to input gray-scale levels having high frequency of appearance in the (m,n)-th small area, the gray-scale level and its gradient are larger.

By using the input video signal, the luminance quantity calculation unit 153 calculates luminance quantity “Y” representing distribution of spatial luminance in the image, and sends it to the blend ratio calculation unit 154 (S37). In this case, in order to calculate distribution of a local luminance, from gray-scale levels of pixels surrounding a pixel to be processed, an average, a center value, a maximum, a minimum or a standard deviation may be calculated.

Furthermore, the luminance quantity Y may be calculated for each pixel to be processed, or calculated for a surrounding area of the pixel. In the luminance quantity calculation unit 153, the input video signal is processed by an edge-detective spatial smoothing filter. In this case, the processed video signal represents a smoothed image including edges of the input video signal. As to the smoothed image, the luminance quantity Y(u,v) of each pixel is calculated by following equation (4).

$$Y ( u , v ) = {\sum }_{j = - p}^{p} {\sum }_{k = - q}^{q} T ( u , v ) \times B ( u - j , v - k ) \\ \{ \begin{matrix}if \vert x ( u - j , v - k ) - x ( u , v ) \vert \leq ɛ then B ( u - j , v - k ) = x ( \begin{matrix}u - j , \\ v - k\end{matrix} ) \\ if \vert x ( u - j , v - k ) - x ( u , v ) \vert > ɛ then B ( u - j , v - k ) = x ( u , v )\end{matrix} \qquad ( 4 )$$

In the equation (4), “x(u,v)” represents a gray-scale level of a luminance at a pixel (u,v), “B(u,v)” represents the luminance after filtering x(u,v), “ε” represents a threshold set by a luminance-difference, and “T(u,v)” represents a function on which a convolution function for the specific number of taps “t” is superimposed. In this case, the number of taps “t” and the threshold “ε” are desirably adjusted as a suitable value. For example, “t” is desirably set as a diameter of a small area (M×N divided areas) divided from the input video signal, and “ε” is desirable set as 0.02˜0.20 times of maximum “xₘₐₓ” of gray-scale level of the input video signal.

By using the luminance quantity Y, the blend ratio calculation unit 154 calculates a blend ratio α representing, composition degree between the global-gamma signal and the local-gamma signal, and sends it to the gradation conversion unit 155 (S38). The global-gamma signal is gamma characteristic to raise characteristics of gradation of a dark part, and the local-gamma signal is gamma characteristic to raise characteristics of gradation of a bright part. Accordingly, the blend ratio α had better be calculated so that a ratio of the global-gamma signal is higher when the luminance quantity Y is lower and so that a ratio of the local-gamma signal is higher when the luminance quantity Y is higher.

In this case, the blend ratio may be calculated for each pixel, or for each area having a plurality of pixels. In the first embodiment, the blend ratio α(u,v) of each pixel is calculated by following equation (5).

$$α ( u , v ) = \frac{Y ( u , v )}{{x}_{max}} \qquad ( 5 )$$

In the equation (5), “xₘₙ” represents a maximum of gray-scale level of the input video signal.

By using the global-gamma signal G, the local-gamma signal Lₘₙ and the blend ratio α, the gradation conversion unit 155 calculates a video signal “f” having gray-scale level converted from the input video signal, and sends it to the display unit 16 (S39). In the first embodiment, as to a gray-scale level “x(u,v)” corresponding to a pixel position “u” along a horizontal direction and a pixel position “v” along a vertical direction in the input video signal, a video signal “f(u,v)” having gray-scale level converted from the gray-scale level “x(u,v)” is calculated by following equation (6).

f(u,v)=[1−α(u,v)]^{c}×G(x(u,v))+α(u,v)^{c}×Lₘₙ(x(u,v)) (6)

In the equation (6), “c” represents a coefficient of blend strength, which is desirably set in a range “0˜1”. At S39 in FIG. 3, as to all pixels in all small areas (M×N divided areas), each gray-scale level is converted by the equation (6), and the video signal “f” is calculated. Moreover, except for linear combination such as the equation (6), the video signal “f” may be calculated by non-linear combination such as operation of inverse proportion.

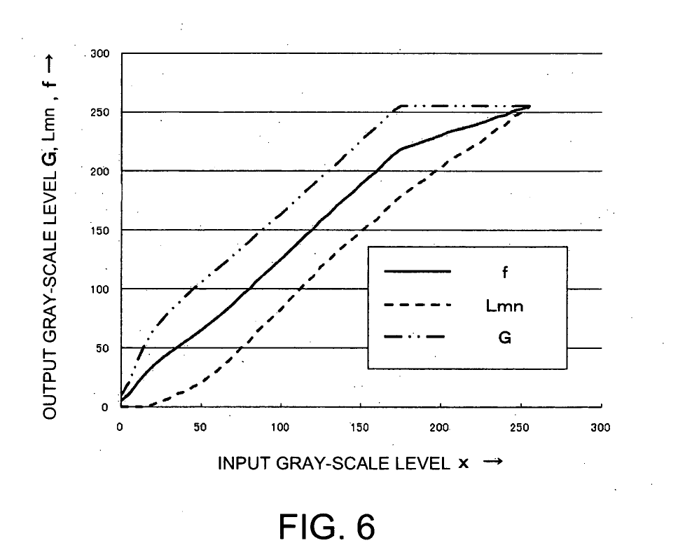

FIG. 6 shows one example of outputs of the global-gamma signal G, the local-gamma signal Lₘₙ and the video signal f for a gray-scale level x of the input video signal. In FIG. 6, assume that “α=0.5 and c=1.0”. As shown in FIG. 6, in the first embodiment, even if the display luminance signal is lower than a maximum, the gray-scale level can be converted on condition that characteristics of gradation of the dark part improves while maintaining characteristics of gradation of the bright part.

The gradation conversion unit 155 decides whether the video signal f of all pixels in (m,n)-th small area is already calculated (S40). If the video signal f of all pixels is already calculated (Yes at S40), processing is forwarded to S41. If the video signal f of at least one pixel is not calculated yet (No at S40), processing is forwarded to S400. In latter case, the luminance quantity calculation unit 153 selects the at least one pixel, and processing is returned to S37 (S400).

The gradation conversion unit 155 decides whether the video signal f of all pixels in all small areas (M×N divided areas) is already calculated (S41). If the video signal f of all pixels in at least one small area is not calculated yet (No at S41), processing is forwarded to S400. The luminance quantity calculation unit 153 selects the at least one small area, and processing is returned to S35 (S410). If the video signal f of all pixels in all small areas is already calculated (Yes at S41), processing is forwarded to S42.

The display unit 16 makes the backlight 161 emit based on the display luminance signal pl, and writes the video signal f into the liquid crystal panel 162. As a result, the image is displayed (S42).

As mentioned-above, in the first embodiment, even if a peak luminance of the display is reduced in order to save the power, characteristics of gradation of a high gray-scale level part or a low gray-scale level part having low frequency of appearance improves. Briefly, uneven luminance of a local area can be suppressed. Furthermore, by using the global-gamma uniformly for the display, occurrence of uneven luminance can be suppressed.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a display unit;
a set unit configured to set a display luminance signal indicating a luminance of the display unit;
a first calculation unit configured to calculate a first gamma characteristic signal of an image to be displayed, based on the display luminance signal and gray-scale levels of pixels of the image;
a second calculation unit configured to calculate a second gamma characteristic signal of each area of the image, based on gray-scale levels of pixels of each area; and
a conversion unit configured to convert a gray-scale level of each pixel of the image, based on the first gamma characteristic signal and the second gamma characteristic signal of an area including a pixel to be converted in the image;
wherein the display unit displays the image in which the gray-scale level of each pixel was converted, based on the display luminance signal.

2. The apparatus according to claim 1,
wherein the conversion unit comprises
a luminance quantity calculation unit configured to calculate a luminance quantity of a surrounding area of the pixel;
a blend ratio calculation unit configured to calculate a blend ratio between the first gamma characteristic signal and the second gamma characteristic signal, based on the luminance quantity; and
a gradation conversion unit configured to convert the gray-scale level of each pixel, based on the first gamma characteristic signal, the second gamma characteristic signal and the blend ratio.

3. The apparatus according to claim 2,
wherein the luminance quantity calculation unit calculates the luminance quantity, based on an average luminance of the surrounding area of the image smoothed in which edges are remained.

4. The apparatus according to claim 1,
wherein the first calculation unit generates the first gamma characteristic signal to suppress a loss of gradation of at least one part having low gray-scale level in the image, and
wherein the second calculation unit generates the second gamma characteristic signal to suppress a loss of gradation of at least one part having high gray-scale level in the image.

5. The apparatus according to claim 4,
wherein blend ratio calculation unit calculates the blend ratio so that a ratio of the first gamma characteristic signal becomes higher when the luminance quantity becomes higher.

6. The apparatus according to claim 1,
wherein the set unit sets the display luminance signal so that the luminance is high when an illuminance measured is high and so that the luminance is low when the illuminance is low.

7. An image display method comprising:
setting a display luminance signal indicating a luminance of a display;
calculating a first gamma characteristic signal of an image to be displayed, based on the display luminance signal and gray-scale levels of pixels of the image;
calculating a second gamma characteristic signal of each area of the image, based on gray-scale levels of pixels of each area;
converting a gray-scale level of each pixel of the image, based on the first gamma characteristic signal and the second gamma characteristic signal of an area including a pixel to be converted in the image; and
displaying the image in which the gray-scale level of each pixel was converted via the display, based on the display luminance signal.
